(19) United States
(12) Patent Application Publication
(10) Pub. No.: US 2011/0139955 A1
(43) Pub. Date: Jun. 16, 2011

(54) Vanity display

(76) Inventor: Ciro Lombardo, Norridge, IL (US)

(21) Appl. No.: 12/931,943

(22) Filed: Feb. 15, 2011

Related U.S. Application Data
(63) Continuation of application No. 12/378,920, filed on Feb. 21, 2009, now abandoned.

(51) Int. Cl. A47G 1/24; F16M 13/02

(52) U.S. Cl. 248/474; 248/205.1

(57) ABSTRACT

An aesthetically pleasing vanity display is provided. The vanity display includes a back and a bottom. First and second sides are connected to the back and to the bottom. An arm, connected to the back, is provided for selectively angling the vanity display. At least one adjustable support bar is connected to a cover bar having overhangs, and the overhangs of the cover bar are connected to the first and second sides of the vanity display.

### CROSS-REFERENCE TO RELATED APPLICATION

None.

### BACKGROUND OF THE INVENTION

The use of cosmetics to beautify human appearance has been a practice for thousands of years. For example, in Ancient Egypt, aristocrats applied minerals to their faces to provide color and definition of features. The Greeks were also known to paint their faces. The Romans used oil-based perfumes in baths and fountains, and on their weapons. The Roman Lucian is noted to have talked about women and cosmetics in his time, referring to their polishing their teeth and eyebrows. About 100 AD in Rome, Platus wrote “A woman without paint is like food without salt.”

The commercial cosmetics industry saw its earliest substantial growth in the beginning of the 20th century. The introduction of makeup use in the cinema, and later, in conjunction with the introduction of color films helped to create a boom in the cosmetic industry. Actress Theda Bara caused a sensation when she appeared on the screen heavily adorned by the cosmetics of Helena Rubinstein. Ms. Rubinstein developed mascara, as well as the concept of colored powder. She borrowed the idea of color-shaded eyes from the French stage and accentuated mouths by reddening them. Max Factor contributed to the cosmetic industry with a variety of powders, including pancake make-up. Improvements in these products were the result of developments in film technology, because technicolor movies and color television required adjustments in makeup to achieve the desired effects.

Today the American cosmetics and beauty aid industry totals over $20 billion in sales and is dominated by hair and skin care products that are heavily advertised in print and on television. The options for obtaining and using numerous colors and effects for self-beautification are plentifold. The storage and management of individual make-up containers continues to provide opportunities for improvement throughout the industry. Makeup can easily become damaged due to heat or loosening of the powder within a container due to throwing the container into a drawer or purse. Further, it can often be difficult to locate a specific desired makeup from a drawer or purse littered with individual makeup containers stored in a disorganized fashion.

Known storage containers fail to provide aesthetically pleasing and useful display containers for makeup. For example, U.S. Pat. No. 5,401,094 concerns a recessed medicine cabinet using separate cabinet components related to a flush mounted cabinet and a recessed cabinet, each having a rear wall and peripheral walls projected forwardly therefrom and defining a storage space. The flush mounted cabinet component is larger both horizontally and vertically than the recessed cabinet component and a framed opening in a structural wall, suited to be mounted flush against the structural wall over the framed opening. The recessed cabinet component peripheral walls are sized to fit into the framed opening, and through an opening in the flush mounted cabinet component rear wall. The overall medicine cabinet storage space is comprised of both cabinet component storage spaces, the recessed cabinet component storage space lying rearwardly of the flush mounted cabinet component storage space. The flush mounted cabinet component can be positioned on the structural wall over the framed opening somewhat independently of its location, as the rear wall opening is located and formed on site as needed during cabinet installation to expose the framed opening for insertion of the recessed cabinet component into the framed opening.

U.S. Pat. No. 5,165,534 deals with a packaging case for storing and presenting elongated objects, such as pencils, and flat objects, such as computer disks. The case includes a base having a plurality of upright partitions hingedly attached thereto at spaced locations, and at least one shelf attached to the partitions. The shelves have openings for receiving the objects and holding them parallel to the partitions. When the partitions are upright, the objects are held upright. When the partitions are folded down, the objects and shelves will be close and parallel to the base so as to provide a very compact package for easy transportation and/or storage. The case can be closed by fold-over flaps or ends which are separate from or one piece extensions of the base. The partitions can be urged to their upright positions manually or by elastic bands or springs. The slots can be elongated in directions parallel to the partitions for holding flat objects like computer disks, and perpendicular to the partitions for holding long, thin objects like pencils. The case can be made of one or more pieces of material.

U.S. Pat. No. 4,756,408 shows a display carton for use with articles which cannot independently support themselves in an upright position. The carton is formed so that the back panel forms an angle greater than 90. degrees with the bottom panel to allow such articles to lean back against the back panel. The front panel may also be at the same angle. The bottom is formed from flaps foldably attached to the front, side and bottom panels which function to automatically form the bottom panel when a carton sleeve is opened into carton shape.

U.S. Pat. No. 4,687,099 involves a package for sticks having a head made of a cosmetic product, which package comprises a sliding tray with upstanding walls of which two upstanding opposite walls are near the middle, provided with an incision so that one part or member of the sliding tray can pivot with respect to the other member of the sliding tray, and in one of the members of the sliding tray is fastened means in which can be placed said sticks. The means in which the sticks can be fastened is a piece of double corrugated cardboard or a piece moulded out of plastic. The sliding tray is covered by means of a wrapper.

U.S. Pat. No. 4,527,692 describes a storage container for storing planar packages, such as floppy disks, having a storage bin to which a front cover is pivotally attached so as to be rotatable outwardly and downwardly through an angle placing the front cover to the rear of the storage bin where it serves as a supporting base. Within the storage bin is disposed a wedge rotatably attached, and with an actuating lever, which, when rotated appropriately, causes planar packages stored in the storage bin to be raised into echelon display, enabling observation of information that may be present on the upper margins of the planar surfaces of the packages.

U.S. Pat. No. 4,477,016 is directed to a display carton which is divided into a plurality of cells by way of a cellular separator arrangement. The cellular separator arrangement includes front to rear extending partition members and transversely extending transverse separators. All are cut from a single blank panel and are integrally hinged to one another an associated side, front and rear panels. In the blank there is cut from a single panel carton components in the form of a front panel, a side panel, a rear panel portion a side panel portion, the partition members and the transverse separators.

U.S. Pat. No. 3,259,748 discloses a tilting arrangement for storing medical isotopes.

U.S. Pat. No. 1,850,647 is directed to a foldable display stand for ceramic tiles and similar articles.

U.S. Pat. No. D247,206 shows an ornamental design of a reading rack for children, substantially as shown.

U.S. Pat. No. D375,002 illustrates an ornamental design for a lift rack with divider system, as shown and described.

It can be seen from the foregoing that the need exists for an improved display that overcomes the problem of digging around in drawers or trays to locate a specific make-up item, thereby potentially damaging the item, and to provide an aesthetic arrangement for displaying make-up containers.

### SUMMARY OF THE INVENTION

An aesthetically pleasing and useful vanity display is provided. The vanity display includes a back and a bottom. First and second sides are connected to the back. An arm, connected to the back, is provided for selectively angling the vanity display. At least one adjustable support bar is connected to the first and second sides of the vanity display.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 illustrates a perspective view of an embodiment of a vanity display in accordance with the principles of the present invention.

FIG. 2 illustrates a perspective view of one embodiment of a back of a vanity display constructed in accordance with the principles of the present invention.

FIG. 3 illustrates a support bar and top cover bar constructed in accordance with the principles of the present invention

FIG. 4 illustrates a top view of the support bar and a bottom view of the top bar cover of FIG. 3.

FIG. 5 illustrates a side elevational view of an embodiment of a vanity display constructed in accordance with the principles of the present invention.

FIG. 6 illustrates a side elevational view of another embodiment of a vanity display constructed in accordance with the principles of the present invention.

FIG. 7 illustrates an accessory bar for a vanity display constructed in accordance with the principles of the present invention.

### DETAILED DESCRIPTION OF THE INVENTION

In the following description, specific details are set forth in order to provide a thorough understanding of the invention. However, it will be apparent that the invention may be practiced without these specific details. Without departing from the generality of the invention disclosed herein and without limiting the scope of the invention, the discussion that follows will refer to the invention as depicted in the drawings.

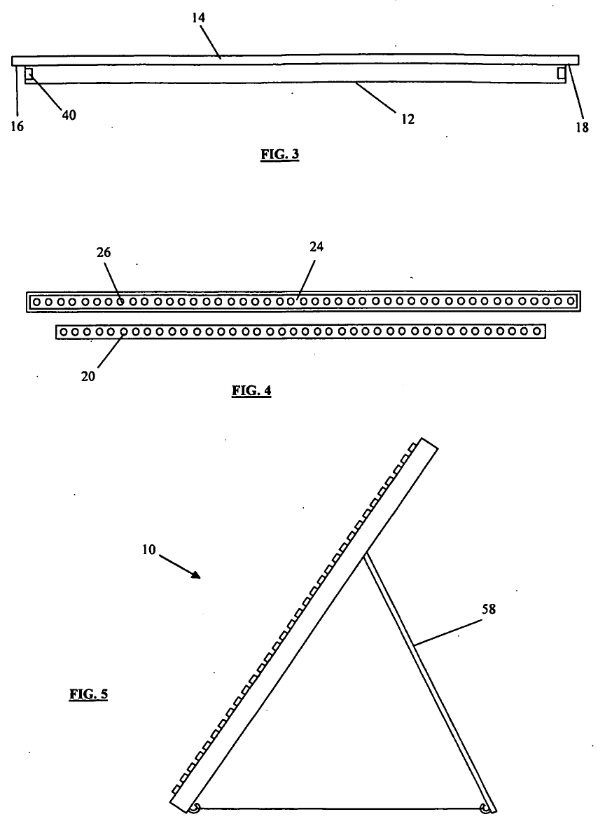

An embodiment of a vanity display in accordance with the principles of the present invention is shown in FIG. 1. The sleek vanity display 10 includes at least one and preferably six adjustable support bars, such as support bar 12. Although there is no limit to the size of the display or number of support bars, the embodiments shown are designed to achieve a pleasing aesthetic appearance for the vanity display. Both the length and depth of the support bar 12 can vary considerably, depending on the item to be supported. For example, where common eye shadow containers are the item to be supported, the support bar 12 can have a depth in the range of approximately ½ to ¾ inches. The support bars are secured to support cover bars, such as support cover bar 14. The support cover bars 14 include overhangs 16, 18, illustrated in FIG. 3. The support bars, such as support bar 12, are selected to be of minimal depth to help achieve the sleek appearance of the vanity display and maximize visual and physical access to the cosmetics containers on the bars, while having sufficient depth to retain cosmetics containers securely. The support bars can include at least one support bar protrusion 20, as illustrated in FIG. 4.

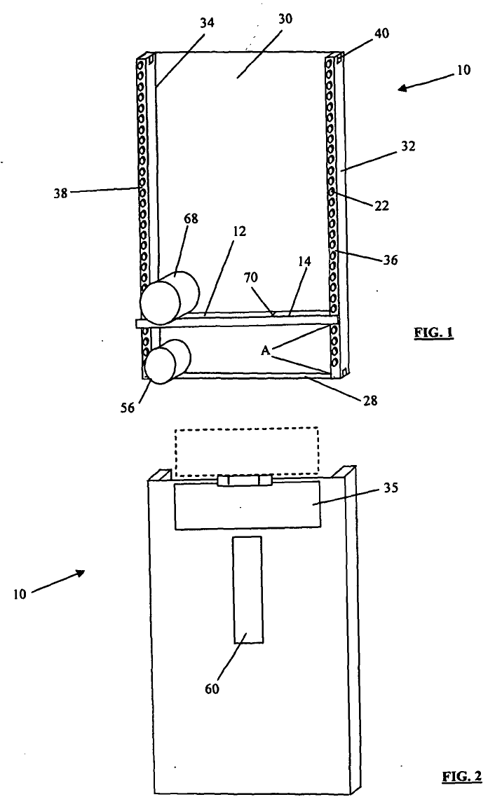

The vanity display includes a bottom 28, a back 30, a first side 32, and a second side 34. The first and second sides 32,34 of the vanity display 10 include a plurality of overhang support tabs 22 disposed equidistant from one another along a top surface 36, 38 of the first and second sides 32,34, respectively. The support tabs 22 can be formed of any suitable interlocking type of shape size and material, such as raised tabs similar to those provided on Lego pieces. Preferably, although not necessarily, the tabs 22 are smaller than typically Lego tabs. For example, the tabs 22 can be 9/64″, compared to the 3/16″ standard Lego tab. The smaller size of the tabs 22 enhances the overall appearance of the vanity display 10 while providing sufficient securing strength. Further, the tabs 22 can be of any suitable size and shape, such as raised rectangle, logos, ovals, or any other shape where a pleasing appearance is achieved for the assembled vanity display 10. In addition, a bottom side 24 of the support cover bar 14 includes interlocking receptacles 26 for securing the overhangs 16,18 to at least one of the tabs 22 of the first and second sides 32,34. The display can also include an optional hinged mirror 35, as illustrated in FIG. 2.

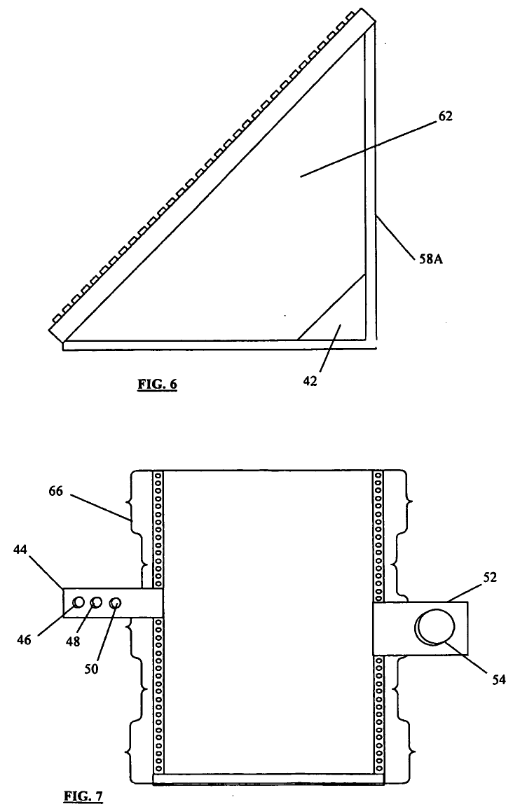

The appearance of the display can be further enhanced by providing a solid surface for the top cover bar 14 that covers the support bar 12. The top cover bar 14 interlocks with the support bar protrusion 20. Further, the first and second sides 32, 34 as well as the adjustable support bars 12 can be formed of a light transmitting material, such as Plexiglass or Lexan. At least one light source 40 can then be provided within at least one of the support bars 12, as illustrated in FIG. 3 and the first and second sides 32,34, as illustrated in FIG. 1 to illuminate the vanity display 10. Alternatively, a light source 42 can be operatively connected to the vanity display 10, as illustrated in FIG. 6. A particularly pleasing affect is achieved where the support bars 12 are illuminated, the top cover bar 14 is secured to the at least one protrusion 20, and the back 30 is made of glass or mirrored glass.

The back 30 of the display can be formed from a variety of sufficiently rigid and durable materials, such as glass, Plexiglass, wood, mirrored glass, and metal. Advantageously, the material should also be chosen to maximize its aesthetic appearance. Further, the size of the back 30 of the display 10 should be any size up to approximately 8″×10″ inches. For example, with an 8″×10″ inch display, 5 large or 6 small eye shadow containers can be accommodated on each support bar 12. Although the increasing the height of the back 30 of the display 10 and the number of adjustable support bars 12 beyond an 8×10 inch size would not detract significantly from the appearance, it is contemplated that increasing the width much beyond 8 inches would most likely negatively affect the appearance and convenience of the display 10.

The tabs 22 of the first and second sides 32,34 are suitable for securing an interlocking accessory bar, such as the accessory bar 44 illustrated in FIG. 7. The accessory bar 44 can include, for example, 3 ovals 46, 48, 50 having no more than a 5/16 inch diameter, to support brushes, applicators, cotton swabs, or other makeup accessories. A suitable accessory bar 44 can be 1½ inches in length, and extend outwardly from one of the first and second sides 32,34 away from the back 30 of the display 10. A second accessory bar 52 could also include one large opening 54 for holding, for example, lipstick or mascara.

In operation, loosening of the top cover bar 14 allows for adjustment of the distance between rows, denoted A in FIG. 1. The distance A can be adjusted to accommodate makeup containers 56, such as eye shadow containers, of varying sizes.

The display 10 is angled back. A suitable angle for the display 10 is any acute angle with respect to a table surface on which the display 10 rests that is sufficient to cause the cosmetic container 56 to lean back far enough so that it can be contained by the support bar 12 on which it sits. As such, the containers 56 are supported by both the support bar 12 and the angle of the display 10. A back 30 of the display 10 includes an arm 58, illustrated in FIG. 5 for holding the display in angled relation to the vanity surface. The arm 58 can be either height adjustable or fixed, and can be of any size and configuration to support the vanity display 10 in an angled position relative to the vanity surface. A slot 60 can be provided on the back 30 to hold the arm 58, as shown in FIG. 2. The arm 58 can also be a known support mechanism, such as a plate holder. The arm 58 can be formed from a variety of materials, such as glass, Plexiglass, wood, mirrored glass, metal, or any other suitably rigid and durable material that achieves a desired overall aesthetically pleasing result. Further, left and right triangular ends 62 (shown in FIG. 6), 64 can be provided for connecting an arm 58a to the back 30 of the vanity display 10. Decorative side or top elements, such as sides 66 can be attached or integrally connected to the display 10 to enhance the aesthetic appearance of the display 10.

Generally the container 56 will have a greater depth 68 then a depth 70 of the support bar 12. For example, where the container 56 is a small or large eye shadow container, the depth 68 can range from approximately 3¼ to 5 inches, respectively. As a result, a depth ratio range of 2:13 to 3:20 is typically achieved.

A method for displaying makeup on a vanity surface is also provided. The method includes the step of placing a vanity display 10 on the vanity surface. Next, at least one support bar 12 of the vanity display 10 is adjusted by securing the at least one support bar 12 to first and second sides 22 of the vanity display 10 via the top cover bar 14 to form a display section to accommodate a particular makeup item 56 of a particular size. The vanity display 10 is then angled with an arm, either 58 or 58a of the vanity display 10, wherein the makeup 56 is supported on the vanity display 10 by both the support bar 12 and the angle of the vanity display 10. Finally, makeup 56 is placed on the support bar 12. Additionally, the method can include the step of illuminating at least one of the support bar 12 and the first and second sides 32, 34. Further, the method can include securing an accessory bar 44 to at least one of the first and second sides 32,34 of the vanity display 10.

While this invention has been described in connection with the best mode presently contemplated by the inventor for carrying out his invention, the preferred embodiments described and shown are for purposes of illustration only, and are not to be construed as constituting any limitations of the invention. Modifications will be obvious to those skilled in the art, and all modifications that do not depart from the spirit of the invention are intended to be included within the scope of the appended claims. Those skilled in the art will appreciate that the conception upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The invention resides not in any one of these features per se, but rather in the particular combinations of some or all of them herein disclosed and claimed and it is distinguished from the prior art in these particular combinations of some or all of its structures for the functions specified.

With respect to the above description then, it is to be realized that the optimum dimensional relationships for the parts of the invention, including variations in size, materials, shape, form, function and manner of operation, assembly and use, and all equivalent relationships to those illustrated in the drawings and described in the specification, that would be deemed readily apparent and obvious to one skilled in the art, are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim as my invention:

1. A vanity display comprising the following:
a back;
a bottom;
first and second sides connected to the back and the bottom;
an arm for angling the vanity display selectively connected to the back; and
at least one adjustable support bar connected to a cover bar having overhangs, wherein the overhangs are connected to the first and second sides of the vanity display.

2. A vanity display in accordance with claim 1, wherein the first and second sides further include at least one tab for interlocking the support bar to the first and second sides of the vanity display.

3. A vanity display in accordance with claim 2, wherein the at least one tab is formed of a shape selected from the group consisting of raised geometric shapes and logos.

4. A vanity display in accordance with claim 1, wherein the at least one support bar is constructed of a light transmitting material.

5. A vanity display in accordance with claim 4, wherein the first and second side are constructed of a light transmitting material.

6. A vanity display in accordance with claim 5, wherein an illumination source is provided and operatively connected to at least one of the first and second sides and the support bar.

7. A vanity display in accordance with claim 1, wherein the depth of containers supported on the at least one support bar is greater than the depth of the support bar.

8. A vanity display in accordance with claim 8, wherein the depth of the support bar is selected from a range of depths from ½ to ¾ inches.

9. A vanity display in accordance with claim 1, wherein the arm is pivotally connected to a slot provided in the back of the vanity display.

10. A vanity display in accordance with claim 9, wherein the height of the arm is adjustable for selectively adjusting the angle of the back of the vanity display.

11. A vanity display in accordance with claim 1, wherein the arm is fixed to the back and where the arm is constructed of the same material as the back of the vanity display.

12. A vanity display in accordance with claim 1, wherein the arm extends from a top edge to a bottom edge of the back of the display.

13. A vanity display in accordance with claim 11, further comprising left and right triangular ends connecting the arm to the back of the vanity display.

14. A vanity display in accordance with claim 1, further comprising at least one accessory bar connected to at least one of the first and second sides of the vanity display.

15. A method for displaying makeup on a vanity surface comprising the steps of:
placing a vanity display on the vanity surface;
adjusting at least one support bar of the vanity display by securing a cover bar, connected to the at least one support bar, to first and second sides of the vanity display to form a display section to accommodate a particular makeup item of a particular size; and
angling the vanity display with an arm of the vanity display, wherein the makeup is supported on the vanity display by both the support bar and the angle of the vanity display; and
placing the makeup on the support bar.

16. A method according to claim 15, further comprising the step of illuminating at least one of the support bar and the first and second sides.

17. A method according to claim 15, further comprising the step of securing an accessory bar to at least one of the first and second sides of the vanity display.

18. An aesthetically pleasing and sleek vanity display comprising:
a first side;
a second side;
a back connecting the first side to the second side;
a series of tabs provided on the first side and the second side;
more than one support bar, each support bar connected to a cover bar having first and second overhangs, wherein the first and second overhangs of each of the cover bars are removably and selectively connected to at least one tab of the series of tabs of the first and second sides of the vanity display; and
an arm connected to the back for angling the vanity display.

19. An aesthetically pleasing and sleek vanity display as claimed in claim 18, further comprising illumination means operatively connected to the vanity display.

20. An aesthetically pleasing and sleek vanity display as claimed in claim 18, further comprising a mirror rotatably hinged to the back of the display.
